(19) United States
(12) Patent Application Publication
(10) Pub. No.: US 2024/0316510 A1
(43) Pub. Date: Sep. 26, 2024

(54) AN INSERT FOR A STATIC MIXER, A STATIC MIXER INCLUDING THE INSERT, USE OF A STATIC MIXER, AND A METHOD OF MAKING AN INSERT FOR A STATIC MIXER

(71) Applicant: Cal Gavin Limited, Alcester Warwickshire (GB)

(72) Inventor: Steven William PERKINS, Alcester Warwickshire (GB)

(21) Appl. No.: 18/574,525

(22) PCT Filed: Jun. 29, 2022
(86) PCT No.: PCT/GB2022/051675

§ 371 Date: Dec. 27, 2023

(30) Foreign Application Priority Data
Jun. 30, 2021 (GB) 2109433.9

(51) Int. Cl. B01F 25/431; B01F 25/00; F28F 13/12

(52) U.S. Cl. CPC B01F 25/43171; F28F 13/12; B01F 2025/916

(57) ABSTRACT

There is provided an insert (110) for a static mixer (100), wherein the static mixer includes the insert and a tube (102). In use, the insert is within the tube. The insert has a first surface (120) including a first leading edge (122) and a first trailing edge (124) joined by a first longitudinal edge (126) and a second longitudinal edge (128). The first surface has a first concave surface portion (130) at or adjacent the first leading edge and a first convex surface portion (132) at or adjacent the first trailing edge.

### FIELD

This specification relates to an insert for a static mixer, a static mixer including the insert, use of a static mixer, and a method of making an insert for a static mixer. More particularly, although not exclusively, this specification relates to static mixers for mixing and/or heat transfer.

### BACKGROUND

By definition, in a static mixer, the mixing elements are an insert (or are rigidly fixed within a pipe, tube, or flow path), and require no moving parts, whereby mixing and/or heat transfer is induced by a flow of fluid(s) over and/or through a static mixer.

JP2012135737A discloses a static mixer with a central hub and vanes to induce swirling flow. The flow induced by prior static mixers results in poor mixing efficiency and/or heat transfer efficiency, for a given pressure drop.

It is a non-exclusive aim of this application to improve mixing and/or heat transfer efficiency.

It is a further non-exclusive aim of this application to provide static mixer inserts which are simple to construct from readily available materials and/or using economical techniques.

### SUMMARY

According to a first aspect there is provided an insert for a static mixer, wherein the static mixer includes the insert and a tube, and, in use, the insert is within the tube; the insert has a first surface including a first leading edge and a first trailing edge joined by a first longitudinal edge and a second longitudinal edge; and the first surface has a first concave surface portion at or adjacent the first leading edge and a first convex surface portion at or adjacent the first trailing edge.

The tube may have a circular cross-section having a radius and the tube may have a trailing edge imaginary cross-sectional concentric circle having a radius of at least 60% of the radius of the tube. The first trailing edge of the first surface may be outside the trailing edge imaginary cross-sectional concentric circle.

The insert may include multiple segments including a first segment and wherein the first segment includes the first surface.

The tube may have a circular cross-section; and the first leading edge of the first surface may be contained inside a first imaginary cross-sectional sector of the tube.

The insert may include a second segment and the second segment may include a second surface including a second leading edge and a second trailing edge joined by a third longitudinal edge and fourth longitudinal edge; and the second surface may have a second concave surface portion at or adjacent the second leading edge and a second convex surface portion at or adjacent the second trailing edge.

The tube may have a circular cross-section; and the second leading edge of the second surface may be contained inside a second cross-sectional sector of the tube.

The insert may include a third segment and the third segment may include a third surface including a third leading edge and a third trailing edge joined by a fifth longitudinal edge and sixth longitudinal edge; and the third surface may have a third concave surface portion at or adjacent the third leading edge and a third convex surface portion at or adjacent the third trailing edge.

The tube may have a circular cross-section; and the third leading edge of the third surface may be contained inside a third cross-sectional sector of the tube.

There may also be provided an insert wherein at least 10 to 45 percent of a length of the first leading edge may be adjacent at least 10 to 45 percent of a length of at least one of the second leading edge, if present, and/or the third leading edge, if present.

The tube may have a circular cross-section having a radius; the insert may have a leading edge imaginary cross-sectional concentric circle having a radius of at least 60% of the radius of the tube, and the first leading edge of the first surface may be outside the leading edge imaginary cross-sectional concentric circle; and/or the second leading edge of the second surface, if present, may be outside the leading edge imaginary cross-sectional concentric circle; and/or the third leading edge of the third surface may be outside the leading edge imaginary cross-sectional concentric circle.

The tube may have a circular cross-section having a radius; and the tube may have a trailing edge imaginary cross-sectional concentric circle having a radius of at least 60% of the radius of the tube; and at least one of: the second trailing edge of the second surface, if present, may be outside the trailing edge imaginary cross-sectional concentric circle; and/or the third trailing edge of the third surface, if present, may be outside the trailing edge imaginary cross-sectional concentric circle.

The tube may have a circular cross-section having a radius; and the tube may have a longitudinal edge imaginary cross-sectional concentric circle having a radius of at most 97% of the radius of the tube, and at least one of: the first longitudinal edge and/or the second longitudinal edge of the first surface may be inside the longitudinal edge imaginary cross-sectional concentric circle; and/or the third longitudinal edge, if present, and/or the fourth longitudinal edge, if present, of the second surface may be inside the longitudinal edge imaginary cross-sectional concentric circle; and/or the fifth longitudinal edge, if present, and/or the sixth longitudinal edge, if present, of the third surface may be inside the longitudinal edge imaginary cross-sectional concentric circle.

In use, flow may proceed from a leading end of the tube to a trailing end of the tube substantially along a Z-axis; and at least one of: the first surface may transition from the first concave surface portion to the first convex surface portion along the Z-axis; and/or the second surface, if present, may transition from the second concave surface portion to the second convex surface portion along the Z-axis; and/or the third surface, if present, may transition from the third concave surface portion to the third convex surface portion along the Z-axis.

The first longitudinal edge and/or the second longitudinal edge of the first surface may include at least one notch; and/or the third longitudinal edge and/or the fourth longitudinal edge of the second surface, if present, may include at least one notch; and/or the fifth longitudinal edge and/or the sixth longitudinal edge of the third surface, if present, may include at least one notch.

In use, flow may proceed from a leading end of the tube to a trailing end of the tube substantially along a Z-axis; and at least two of the following edges may include a notch: the first longitudinal edge; the second longitudinal edge; the third longitudinal edge, if present; the fourth longitudinal edge, if present; the fifth longitudinal edge, if present; and/or the sixth longitudinal edge, if present; and wherein the notches may be offset one another along the Z-axis.

The first trailing edge of the first surface may include at least one notch; and/or the second trailing edge of the second surface, if present, may include at least one notch; and/or the third trailing edge of the third surface, if present, may include at least one notch.

There is also an insert as described above and an additional insert as described above.

The insert and additional insert may be unitary.

There is also provided a static mixer, including a tube and an insert as described above, wherein, in use, the insert is inside the tube.

The static mixer may further comprise multiple inserts.

There is also provided a use of a static mixer as described above in heat transfer and/or mixing.

The use may comprise flowing at least one fluid from the leading end of the tube to the trailing end of the tube.

The use may further comprise flowing the at least one fluid sequentially across the first concave surface portion and then the first convex surface portion.

There is also provided a net for forming an insert as described above.

There is also provided a method of making an insert for a static mixer, the method including: providing a net as described above; and pressing the net and/or folding the net to form an insert as described above.

There is also provided a method of improving a heat exchanger, the method including: inserting an insert as described above into a tube of the heat exchanger.

### BRIEF DESCRIPTION OF THE FIGURES

Embodiments will now be described by way of example only with reference to the accompanying drawings, in which:

FIG. 1 shows a cross-sectional view of an embodiment of a static mixer, including an insert of an embodiment;

FIG. 2 shows a perspective view of the static mixer and insert of FIG. 1;

FIG. 3 shows a cross-sectional leading-edge-facing view of the static mixer and insert of FIG. 1;

FIG. 4 shows a cross-sectional cut-away view of an embodiment of a static mixer including an insert of an embodiment;

FIG. 5 shows a perspective view of the static mixer and insert of FIG. 4;

FIG. 6 shows a cross-sectional leading-edge-facing view of the static mixer and insert of FIG. 4;

FIG. 7 shows a cross-sectional cut-away view of an embodiment of static mixer including inserts of FIG. 4;

FIG. 8 shows a perspective cut-away view of an embodiment of a static mixer, including an insert of an embodiment;

FIG. 9 shows a cross-sectional leading-edge-facing view of the static mixer and insert of FIG. 8;

FIG. 10 shows a perspective cut-away view of an embodiment of a static mixer, including inserts of FIG. 8;

FIG. 11 shows a net for forming an insert of an embodiment;

FIG. 12 shows a net for forming an insert of an embodiment;

FIG. 13 shows a cross-sectional leading-edge-facing view at multiple cross-sections along the Z-axis; and

FIG. 14 shows a graph comparing static mixers including inserts of embodiments, and known static mixers.

### DESCRIPTION OF EMBODIMENTS

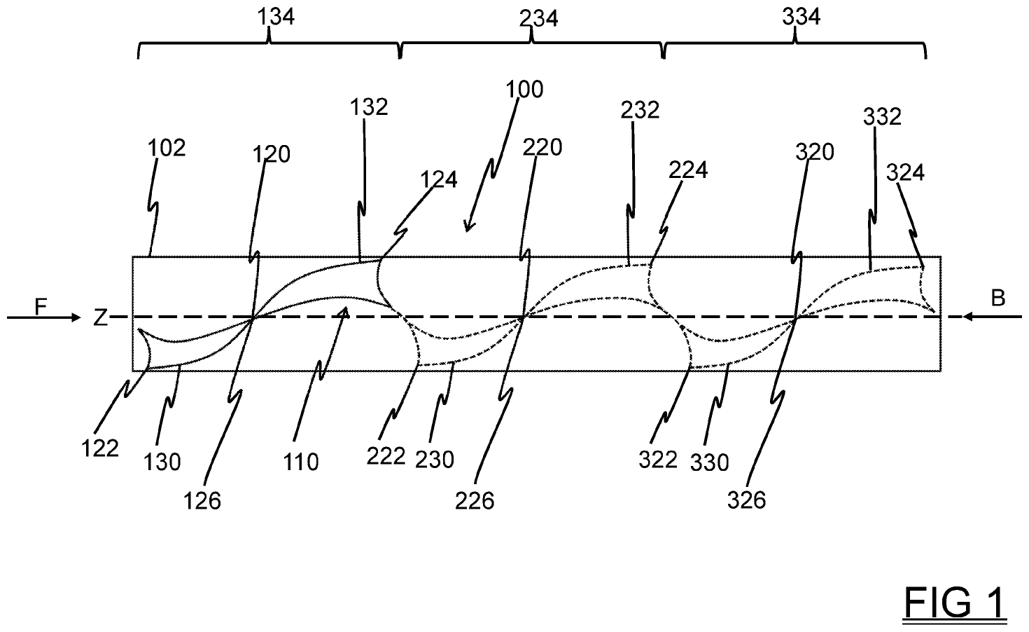

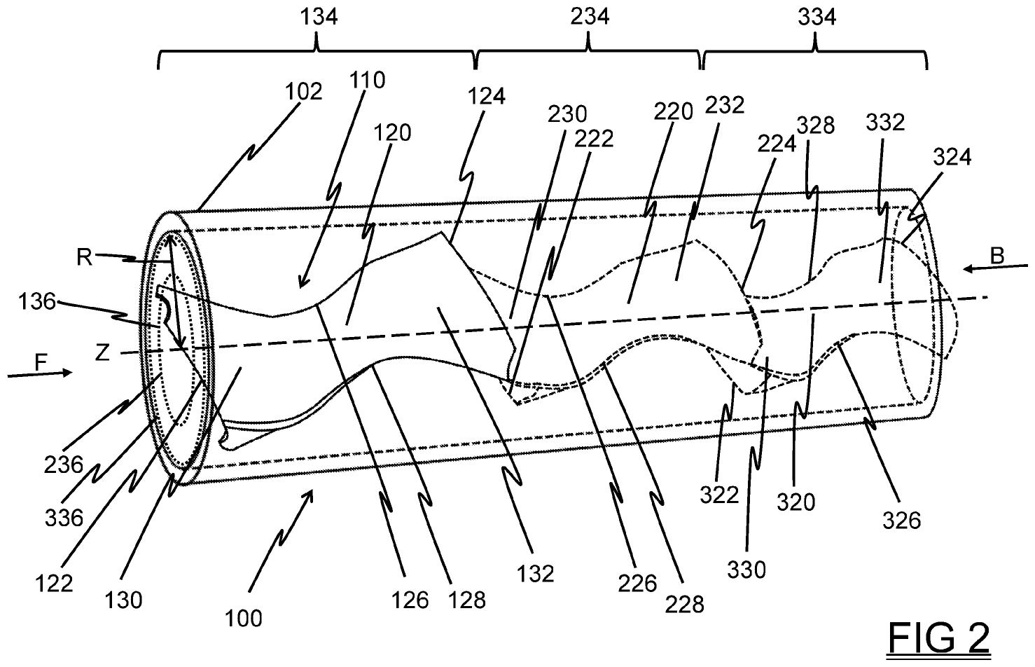

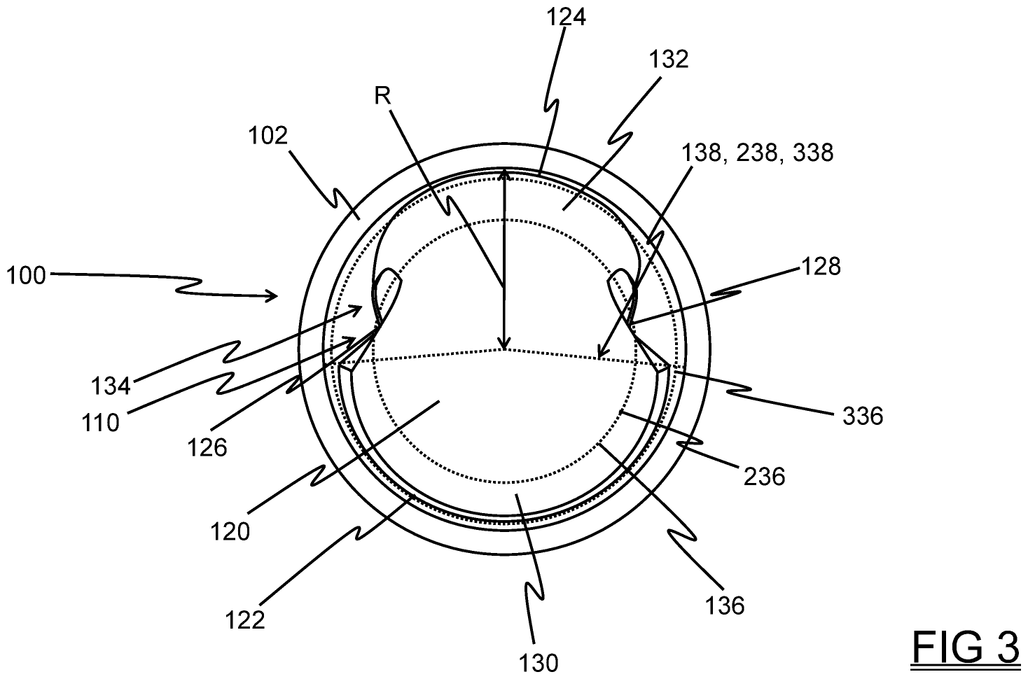

Referring firstly to FIGS. 1, 2, and 3 of the drawings, there is provided an insert 110 for a static mixer 100. The static mixer 100 includes the insert 110 and a tube 102. In use, and as shown, the insert 110 is within the tube 102.

The insert 110 has a first surface 120 including a first leading edge 122 and a first trailing edge 124 joined by a first longitudinal edge 126 and a second longitudinal edge 128. The first surface 120 has a first concave surface portion 130 at or adjacent the first leading edge 122 and a first convex surface portion 132 at or adjacent the first trailing edge 124.

References to concave and convex when used herein may take their common meanings. Accordingly, when used in combination the curvature direction of one curvature (i.e., concave) may be different (e.g., substantially opposite) to that of the other curvature (i.e., convex). Accordingly, there may be a curvature of the first surface 120 at or adjacent the first leading edge 122 in a first direction, and there may be a curvature of the first surface 120 at or adjacent the first trailing edge 124 in a second, opposite direction.

Inserts 110 including a first surface 120 having a first concave surface portion 130 and a first convex surface portion 132 may provide particularly efficient mixing and/or heat transfer of fluid(s). By efficient mixing and/or heat transfer it is meant that the mixing and/or heat transfer is of a relatively large magnitude for a relatively small pressure drop. In particular, the fluid flow, such as radial fluid flow and/or disturbed flow, caused by such an insert 110 has been found to be significant relative to the pressure drop caused. Further, the fluid flow caused by such an insert 110 adjacent the internal wall of the tube 102 has been found to be significant relative to the pressure drop caused; fluid flow adjacent the internal wall of the tube 102 favours heat transfer in particular; a large fluid flow magnitude and/or flow disturbance in general favours mixing. Additionally or alternatively, the insert 110 may cause turbulence in the fluid flow. Turbulence may be favoured in certain fluids or fluid mixtures, such as a mixture of gas(es) and low viscosity fluid(s). The turbulence caused by the insert 110 may be significant to the pressure drop caused, further favouring efficient mixing and/or heat transfer. Additionally, turbulence adjacent the internal wall of the tube 102 favours heat transfer, in particular; turbulence in general favours mixing.

Use of the insert 110 may comprise flowing at least one fluid from the leading end of the tube 102 to the trailing end of the tube 102. Accordingly, in preferred embodiments, the first surface 120 may be configured such that fluid flows sequentially across the first concave surface portion 130 and then the first convex surface portion 132. Alternatively, in less-preferred embodiments, the first surface 120 may be configured such that fluid flows sequentially across the first convex surface portion 132 and then the first concave surface portion 130.

The insert 110 may include multiple segments including a first segment 134, wherein the first segment 134 includes the first surface 120. The tube 102 may have a circular cross-section, and the first leading edge 122 of the first surface 120 may be contained inside a first imaginary cross-sectional sector 138 of the tube 102. Sector takes its normal mathematical meaning of a part of a circle enclosed by two radii of a circle and their intercepted arc. The angle between the two radii of a circle and their intercepted arc of such sectors 138, 238, 338, 438, 538, 638, 738, 838, 938 as described herein may be at most: 180 degrees, or 160 degrees, or 140 degrees, or 130 degrees, or 120 degrees, or 110 degrees, or 100 degrees, or 90 degrees, or 80 degrees, or 70 degrees. The angle between the two radii of a circle and their intercepted arc of such sectors 138, 238, 338, 438, 538, 638, 738, 838, 938 as described herein may be at least: 5 degrees, or 10 degrees, or 30 degrees, or 50 degrees, or 70 degrees, or 80 degrees, or 90 degrees, or 100 degrees, or 110 degrees, or 120 degrees, or 130 degrees, or 140 degrees. The angle between the two radii of a circle and their intercepted arc of such sectors 138, 238, 338, 438, 538, 638, 738, 838, 938 as described herein may be within a range of the angles as described above. In particular, the angle between the two radii of a circle and their intercepted arc of such sectors 138, 238, 338, 438, 538, 638, 738, 838, 938 as described herein may be between 160 and 90 degrees, or between 150 and 100 degrees, or between 130 and 110 degrees; such angles may allow for up to three segments as described herein to be located adjacent one another radially within the tube. The angle between the two radii of a circle and their intercepted arc of such sectors 138, 238, 338, 438, 538, 638, 738, 838, 938 as described herein may be between 130 and 50 degrees, or between, or between 120 and 60 degrees, or between 110 and 70 degrees, or between 100 to 80 degrees; such angle ranges may allow for up to four segments as described herein to be located adjacent one another radially within the tube.

The insert 110 may further include a second segment 234. The second segment 234 may be substantially similar to the first segment 134. For example, the second segment 234 may include a second surface 220 including a second leading edge 222 and a second trailing edge 224 joined by a third longitudinal edge 226 and fourth longitudinal edge 228. The second surface 220 may have a second concave surface portion 230 at or adjacent the second leading edge 222 and a second convex surface portion 232 at or adjacent the second trailing edge 224. Accordingly, there may be a curvature of the second surface 220 at or adjacent the second leading edge 222 in a first direction, and there may be a curvature of the second surface 220 at or adjacent the second trailing edge 224 in a second, opposite direction. The tube 102 may have a circular cross-section, and the second leading edge 222 of the second surface 220 may be contained inside a second cross-sectional sector 238 of the tube 102.

Inserts 110 including a first segment 134 and second segment 234 may provide particularly efficient mixing and/or heat transfer of fluids. In particular, flow from the first trailing edge 124 to the second leading edge 222 may provide greater flow disturbance than the flow disturbance at the first leading edge 122. Additionally or alternatively, inserts 110 including a first segment 134 and second segment 234 may provide particularly efficient mixing and/or heat transfer of fluids through turbulent flow. Turbulence may be favoured in certain fluids or fluid mixtures, such as a mixture of gas(es) and low viscosity fluid(s). Turbulence in general favours mixing. In particular, flow from the first trailing edge 124 to the second leading edge 222 may provide greater turbulence in the fluid(s) than the turbulence at the first leading edge 122.

The insert 110 may further include a third segment 334. The third segment 334 may be substantially similar to the first segment 134, and/or the second segment 234. For example, the third segment 334 may include a third surface 320 including a third leading edge 322 and a third trailing edge 324 joined by a fifth longitudinal edge 326 and sixth longitudinal edge 328. The third surface 320 may have a third concave surface portion 330 at or adjacent the third leading edge 322 and a third convex surface portion 332 at or adjacent the third trailing edge 324. Accordingly, there may be a curvature of the third surface 320 at or adjacent the third leading edge 322 in a first direction, and there may be a curvature of the third surface 320 at or adjacent the third trailing edge 324 in a second, opposite direction. The tube 102 may have a circular cross-section, and the third leading edge 322 of the third surface 320 may be contained inside a third cross-sectional sector 338 of the tube 102.

As shown, the first segment 134, second segment 234, and/or third segment 334 may be positioned adjacent one another along a Z-axis Z of the tube 102.

Use of the insert 110 may comprise flowing at least one fluid from the leading end of the tube 102 to the trailing end of the tube 102 substantially along a Z-axis Z. Accordingly, the insert 110 may be configured such that fluid flows sequentially across the first segment 134, then the second segment, 234, if present, and then, if present, the third segment 334 in a first direction F. The first surface 120 may be configured such that fluid flows sequentially across the first concave surface portion 130 and then the first convex surface portion 132. The second surface 220 may be configured such that the fluid then flows sequentially across the second concave surface portion 230 and then the second convex surface portion 232. The third surface 320, if present, may be configured such that the fluid then flows sequentially across the third concave surface portion 330 and then the third convex surface portion 332. With reference to the flow direction F and leading edges, fluid(s) may flow sequentially over the first leading edge 122, second leading edge 222, if present, and/or the third leading edge 322, if present, as described above. Alternatively, the insert 110 may be configured such that fluid flows sequentially across the third segment 334, if present, and then the second segment 234, and then the first segment 134 in a second direction B. The third surface 320, if present, may be configured such that fluid flows sequentially across the third convex surface portion 332 and then the third concave surface portion 330. The second surface 220 may be configured such that fluid flows sequentially across the second convex surface portion 232 and then the second concave surface portion 230. The first surface 120 may be configured such that fluid flows sequentially across the first convex surface portion 132 and then the first concave surface portion 130. With reference to the flow direction B and trailing edges, fluid(s) may be flowed in the reverse direction B, and the flow may flow sequentially over the third trailing edge 324, if present, second trailing edge 224, if present, and first trailing edge 124, as described above.

Inserts 110 further including a second segment 234 and/or a third segment 334 may provide particularly efficient mixing of fluid(s) and/or heat transfer by maintaining a multidirectional and/or radial flow throughout the tube 102, increasing the convective heat transfer and/or disturbance of the flow along the Z-axis Z of the tube 102 in the direction of flow. The flow disturbance at the second segment 234 and third segment 334 may be greater than at the first segment 134. Flow from the first trailing edge 124 to the second leading edge 222 may provide greater disturbance than the disturbance at the first leading edge 122, and flow from the second trailing edge 224 to the third leading edge 322 may provide greater disturbance than the disturbance at the second leading edge 222. Increasing the number of segments may increase the flow disturbance at each leading edge of each subsequent segment, respectively, proportional to the number of segments. Additionally or alternatively, inserts 110 including a second segment 234 and/or a third segment 334 may further provide particularly efficient mixing of fluid(s) and/or heat transfer by maintaining turbulent flow throughout the tube 102, increasing the convective heat transfer and/or turbulence of the flow along the Z-axis Z of the tube 102 in the direction of flow. The turbulence at the second segment 234 and third segment 334 may be greater than at the first segment 134. Flow from the first trailing edge 124 to the second leading edge 222 may provide greater turbulence than the turbulence at the first leading edge 122, and flow from the second trailing edge 224 to the third leading edge 322 may provide greater turbulence than the turbulence at the second leading edge 222.

The tube 102 may also have a circular cross-section having a radius R, and the insert may have a leading edge imaginary cross-sectional concentric circle 136 having a radius of at least 10%; 20%; 30%; 40%; 50%; 60%; 70%; 80%; or 90% of the radius R of the tube 102. At least one of the first leading edge 122 of the first surface 120 may be outside the leading edge imaginary cross-sectional concentric circle 136. The second leading edge 222 of the second surface 220 may be outside the leading edge imaginary cross-sectional concentric circle 136. The third leading edge 322 of the third surface 320 may be outside the leading edge imaginary cross-sectional concentric circle 136.

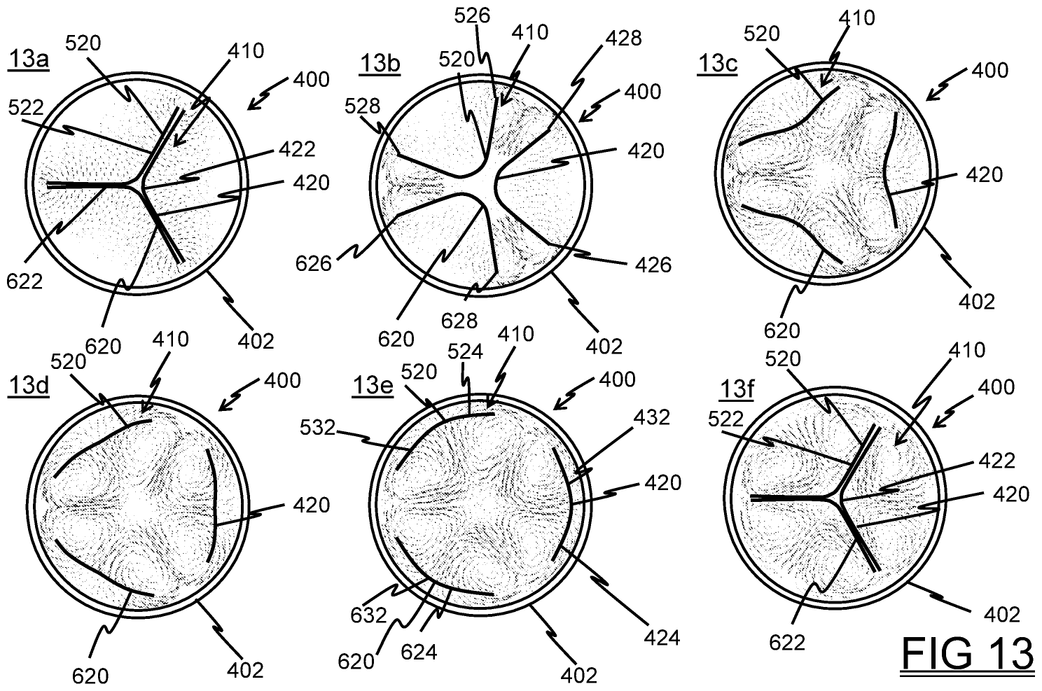

Inserts 110 as described above, with reference to the leading edge imaginary cross-sectional concentric circle 136, may provide particularly efficient mixing of fluid(s) and/or efficient heat transfer by maintaining a disturbed flow throughout the tube 102, and increasing the disturbance of the flow along the Z-axis Z of the tube 102 in the direction of flow. In particular, flow may be directed away from the internal wall of the tube 102 along the first surface 120, and/or the second surface 220, and/or the third surface, increasing disturbance in the flow, and may induce efficient mixing and/or heat transfer. Further, flow across the trailing edges and longitudinal edges may induce a flow perpendicular to Z-axis Z, which may provide efficient mixing and/or heat transfer of fluid(s). Flow from the first trailing edge 124 to the second leading edge 222 may provide greater flow disturbance than the disturbance at the first leading edge 122, and flow from the second trailing edge 224 to the third leading edge 322 may provide greater disturbance than the disturbance at the second leading edge 222. Increasing the number of segments may increase the flow disturbance at each leading edge of each subsequent segment, respectively, proportional to the number of segments. Additionally or alternatively, inserts 110 as described above, with reference to the leading edge imaginary cross-sectional concentric circle 136, may also provide particularly efficient mixing of fluid(s) and/or efficient heat transfer by maintaining a turbulent flow throughout the tube 102, and increasing the turbulence of the flow along the Z-axis Z of the tube 102 in the direction of flow. Turbulence may be favoured in certain fluids, such as a mixture of gas(es) and low viscosity fluid(s). The efficient mixing and/or heat transfer is explained in further detail below with reference to FIG. 13.

The tube 102 may have a trailing edge imaginary cross-sectional concentric circle 236 having a radius of at least 10%; 20%; 30%; 40%; 50%; 60%; 70%; 80%; or 90% of the radius R of the tube 102. At least one of the first trailing edge 124 of the first surface 120 may be outside the trailing edge imaginary cross-sectional concentric circle 236; and/or the second trailing edge 224 of the second surface 220, if present, may be outside the trailing edge imaginary cross-sectional concentric circle 236; and/or the third trailing edge 324 of the third surface 320, if present, may be outside the trailing edge imaginary cross-sectional concentric circle 236.

Inserts 110 as described above, with reference to the trailing edge imaginary cross-sectional concentric circle 236, may provide efficient mixing and/or heat transfer. In particular, flow disturbance and/or radial flow may be increased at the first trailing edge 124, the second trailing edge 224, and the third trailing edge 324. Fluid flow adjacent the internal wall of the tube 102 caused by such an insert 110 has been found to be significant relative to the pressure drop caused; fluid flow adjacent the internal wall of the tube 102 in general favours heat transfer; disturbed flow and radial flow in general favours mixing. The efficient mixing and/or heat transfer is explained in further detail below with reference to FIG. 13.

The tube 102 may have a longitudinal edge imaginary cross-sectional concentric circle 336 having a radius of at most 97%; 95%; 90%; 85%; 80%; 70%; 60%; 50%; 40%; or 35% of the radius R of the tube. At least one of the first longitudinal edge 126 and/or the second longitudinal edge 128 of the first surface 120 may be inside the longitudinal edge imaginary cross-sectional concentric circle 336; and/or the third longitudinal edge 226, if present, and/or the fourth longitudinal edge 228, if present, of the second surface 220 may be inside the longitudinal edge imaginary cross-sectional concentric circle 336; and/or the fifth longitudinal edge 326, if present, and/or the sixth longitudinal edge 328, if present, of the third surface 320 may be inside the longitudinal edge imaginary cross-sectional concentric circle 336.

Inserts 110 as described above, with reference to the longitudinal edge imaginary cross-sectional concentric circle 336, may provide efficient mixing and/or heat transfer of fluid(s). Flow may be induced over the first longitudinal edge 126 and/or the second longitudinal edge 128 of the first surface 120; and/or the third longitudinal edge 226, if present, and/or the fourth longitudinal edge 228, if present, of the second surface 220; and/or the fifth longitudinal edge 326, if present, and/or the sixth longitudinal edge 328 of the third surface 320, if present. Further, flow disturbance and radial flow may be increased at the first longitudinal edge 126 and/or the second longitudinal edge 128 of the first surface 120; and/or the third longitudinal edge 226, if present, and/or the fourth longitudinal edge 228, if present, of the second surface 220; and/or the fifth longitudinal edge 326, if present, and/or the sixth longitudinal edge 328 of the third surface 320, if present. The efficient mixing and/or heat transfer is explained in further detail below with reference to FIG. 13.

Use of the insert 110 may include flowing at least one fluid from a leading end of the tube to a trailing end of the tube substantially along a Z-axis Z. At least one of the first surface 120 may transition from the first concave surface portion 130 to the first convex surface portion 132 along the Z-axis Z; and/or the second surface 220, if present, may transition from the second concave surface portion 230 to the second convex surface portion 232 along the Z-axis Z; and/or the third surface 320, if present, may transition from the third concave surface portion 330 to the third convex surface portion 332 along the Z-axis Z.

Inserts 110 as described above, with reference to the transition in the first surface 120, second surface 220, and third surface 320, may provide efficient mixing and/or heat transfer of fluid(s). The transition may be smooth. The smooth transition may allow for low pressure drop in the flow direction along the Z-axis Z in the fluid, whilst maintaining efficient mixing and/or heat transfer of the fluid(s). The efficient mixing and/or heat transfer is explained in further detail below with reference to FIG. 13.

The first leading edge 122, second leading edge 222, and third leading edge 322, may be positioned at the bottom of the tube 102 (as shown in FIGS. 1 to 3). In use, fluid(s) may flow in a direction F. Accordingly, in direction F, fluid may flow sequentially across the first segment 134, then the second segment, 234, if present, and then the third segment 334, if present; fluid(s) may flow sequentially over the first leading edge 122, second leading edge 222, if present, and/or the third leading edge 322, if present, as described above. The first leading edge 122, second leading edge 222, if present, and third leading edge 322, if present, being positioned at the bottom of the tube 102 may be advantageous for 2-phase flow, particular for a fluid mixture containing a more dense fluid, and a less dense fluid (e.g. a liquid and a gas). An advantage of flowing the fluid(s) in the first direction F may result in the more dense fluid(s) being raised from the bottom of the tube 102 into the less dense fluid(s). Alternatively, in use, fluid(s) may be flowed in the reverse direction B, and the flow would flow sequentially over the third trailing edge 324, if present, second trailing edge 224, if present, and first trailing edge 124, as described above. In the case of the reverse flow B, dense fluid(s) may flow along the bottom of the tube and around the insert 110 less-dense fluid(s) may be directed from the top of the tube 102 into the dense fluid(s). The reverse flow direction B may induce less flow disturbance than when flow is in the direction F.

The insert 110 as described above should not be considered to be limited to including one, or two, or three segments, and may include multiple segments, including, but not limited to, four, five, ten, fifty, one-hundred, one-thousand, or one-hundred-thousand segments.

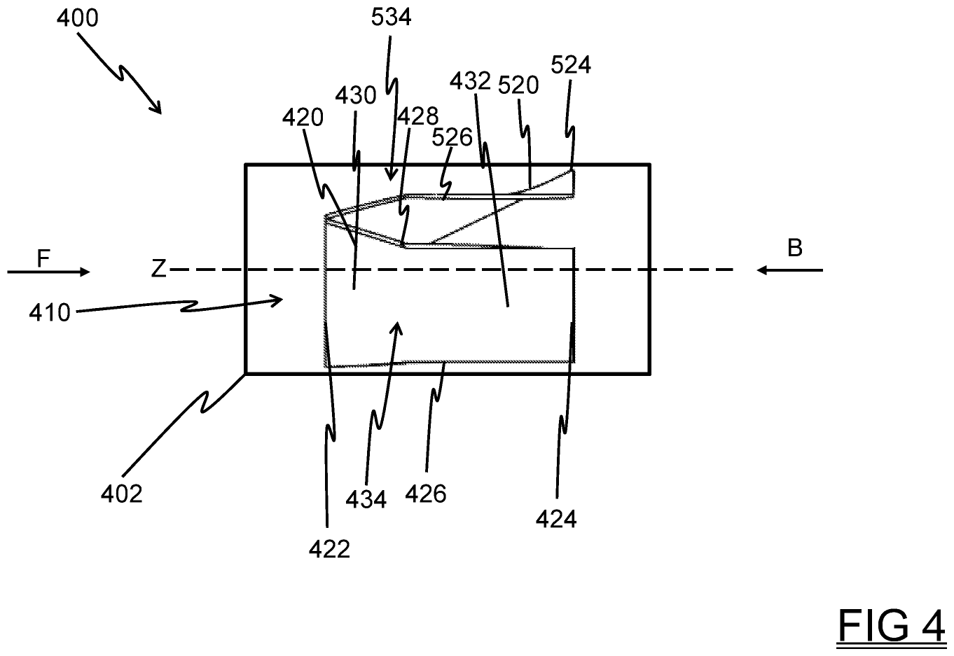

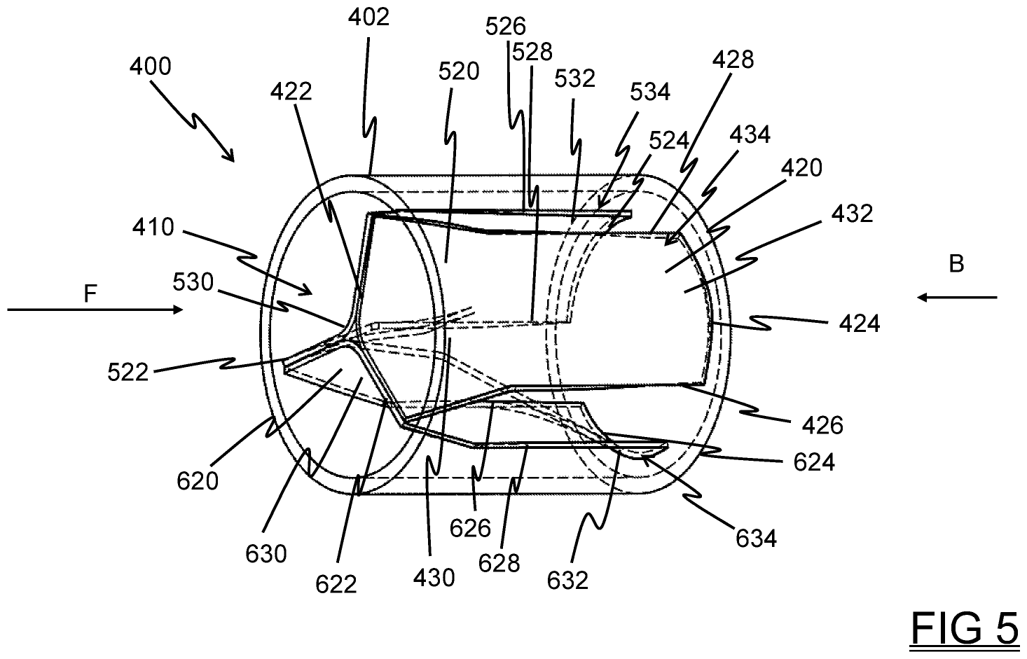

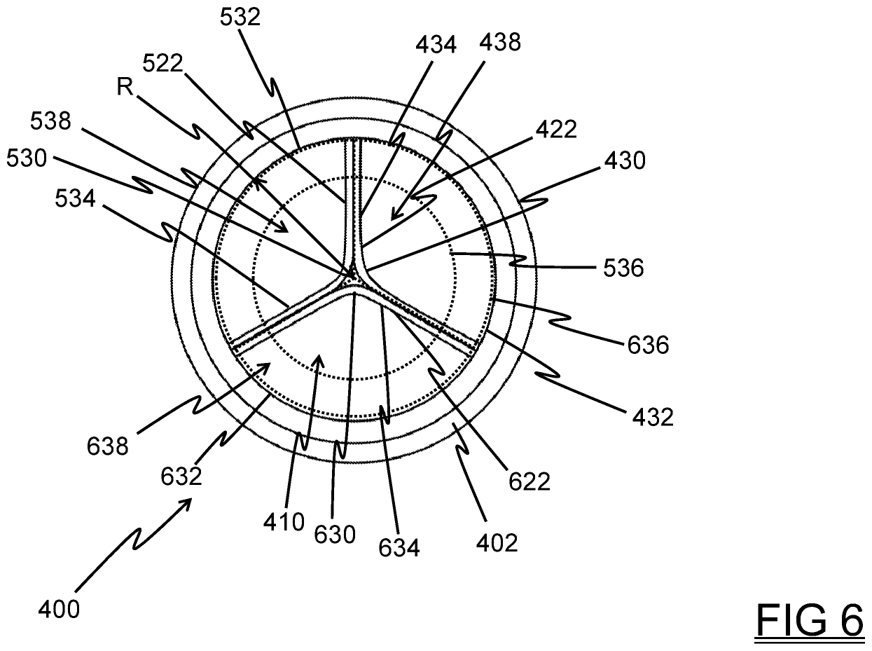

Referring to FIGS. 4, 5, and 6, there is provided a further insert 410 for a static mixer 400. The insert 410 and static mixer 400 are described with reference numerals having like numerals to those of insert 110 and static mixer 100 with the addition of 300. Features and advantages described with reference to insert 110 and static mixer 100 may be combined or obtained with insert 410 and static mixer 400, where appropriate. The static mixer 400 includes the insert 410 and a tube 402. In use, and as shown, the insert 410 is within the tube 402. The insert 410 has a first surface 420 including a first leading edge 422 and a first trailing edge 424 joined by a first longitudinal edge 426 and a second longitudinal edge 428. The first surface 420 has a first concave surface portion 430 at or adjacent the first leading edge 422 and a first convex surface portion 432 at or adjacent the first trailing edge 424. Accordingly, there may be a curvature of the first surface 420 at or adjacent the first leading edge 422 in a first direction, and there may be a curvature of the first surface 420 at or adjacent the first trailing edge 424 in a second, opposite direction.

The insert 410 may have multiple segments including a first segment 434 and wherein the first segment 434 includes the first surface 420.

The tube 402 may have a circular cross-section and the first leading edge 422 of the first surface 420 may be contained inside a first cross-sectional sector 438 of the tube 402.

The insert 410 may further include a second segment 534 and the second segment 534 may include a second surface 520 including a second leading edge 522 and a second trailing edge 524 joined by a third longitudinal edge 526 and fourth longitudinal edge 528. The second surface 520 may have a second concave surface portion 530 at or adjacent the second leading edge 522 and a second convex surface portion 532 at or adjacent the second trailing edge 524. Accordingly, there may be a curvature of the second surface 520 at or adjacent the second leading edge 522 in a first direction, and there may be a curvature of the second surface 520 at or adjacent the second trailing edge 524 in a second, opposite direction.

The second leading edge 522 of the second surface 520, if present, may be contained inside a second cross-sectional sector 538 of the tube 402.

The insert 410 may further include a third segment 634 and the third segment 634 includes a third surface 620 including a third leading edge 622 and a third trailing edge 624 joined by a fifth longitudinal edge 626 and sixth longitudinal edge 628. The third surface 620 has a third concave surface portion 630 at or adjacent the third leading edge 622 and a third convex surface portion 632 at or adjacent the third trailing edge 624. Accordingly, there may be a curvature of the third surface 620 at or adjacent the third leading edge 622 in a first direction, and there may be a curvature of the third surface 620 at or adjacent the third trailing edge 624 in a second, opposite direction.

The third leading edge 622 of the third surface 620, if present, may be contained inside a third cross-sectional sector 638 of the tube 402.

The first segment 434, the second segment 534, if present, and the third segment 634, if present, may be positioned adjacent radially within the tube 402. The first segment 434, the second segment 534, if present, and the third segment 634, if present, may also be positioned adjacent longitudinally within the tube 402.

Inserts 410 having a first leading edge 422, a second leading edge 522, and a third leading edge 622 positioned adjacent radially within the tube 402 may be advantageous for heat transfer, and/or mixing, and/or construction of the insert 410, when compared to, for example but not limited to, four leading edges. An insert with four leading edges may increase construction time, cost, and potentially risk of breakage when pressing the shape.

At least 10 to 45 percent of a length of the first leading edge 422 may be adjacent at least 10 to 45 percent of a length of at least one of the second leading edge 522, if present, and/or the third leading edge 622, if present. Alternatively, at least 10 to 50 percent; or 5 to 25 percent; or 10 to 60 percent of a length of the first leading edge 422 may be adjacent at least 10 to 50; or 5 to 25 percent; or 10 to 60 percent of a length of at least one of the second leading edge 522, if present, and/or the third leading edge 622, if present.

Inserts 410 as described above, where at least 10 to 45 percent of a length of the first leading edge 422 may be adjacent at least 10 to 45 percent of a length of at least one of the second leading edge 522, if present, and/or the third leading edge 622, if present, may lead to efficient mixing and/or heat transfer. In particular, flow of fluid(s) may be induced from a centre of the tube 402 to the internal wall of the tube 402 and flow of fluid(s) may also be induced from the internal wall of the tube 402 to the centre of the tube 402. Fluid(s) flow may also be restricted from travelling through the centre of the tube 402 at the leading edge 422, 522, 622 of the insert 410, reducing the risk of reducing disturbed flow and/or radial flow of the fluid(s).

There may also be provided an insert 410, wherein the tube 402 may have a circular cross-section having a radius R, and the tube 402 may have a trailing edge imaginary cross-sectional concentric circle 536 having a radius of at least 10%; 20%; 30%; 40%; 50%; 60%; 70%; 80%; or 90% of the radius R of the tube 402. At least one of the first trailing edge 424 of the first surface may be outside the trailing edge imaginary cross-sectional concentric circle 536; and/or the second trailing edge 524 of the second surface 520, if present, may be outside the trailing edge imaginary cross-sectional concentric circle 536; and/or the third trailing edge 624 of the third surface 620, if present, may be outside the trailing edge imaginary cross-sectional concentric circle 536.

A static mixer 400, including an insert 410 and a tube 402, wherein at least one of the first trailing edge 424 of the first surface is outside the trailing edge imaginary cross-sectional concentric circle 536; and/or the second trailing edge 524 of the second surface 520, if present, is outside the trailing edge imaginary cross-sectional concentric circle 536; and/or the third trailing edge 624 of the third surface 620, if present, is outside the trailing edge imaginary cross-sectional concentric circle 536, may provide efficient heat transfer, and/or mixing of fluid(s). In particular, flow may be directed towards an internal wall of the tube 402, increasing heat transfer; flow directed near the internal wall of the tube 402 favours heat transfer, and particularly radial flow near the internal wall of the tube 402 favours heat transfer.

The tube 402 may have a circular cross-section having a radius R; and the tube may have a longitudinal edge imaginary cross-sectional concentric circle 636 having a radius of at most 97%; 95%; 90%; 85%; 80%; 70%; 60%; 50%; 40%; or 35% of the radius R of the tube 402. The insert 410 may include porting on at least one longitudinal edge of the insert 410, in particular: at least one of the first longitudinal edge 426 and/or the second longitudinal edge 428 of the first surface 420 may be inside the longitudinal edge imaginary cross-sectional concentric circle 636; and/or the third longitudinal edge 526, if present, and/or the fourth longitudinal edge 528, if present, of the second surface 520 may be inside the longitudinal edge imaginary cross-sectional concentric circle 636; and/or the fifth longitudinal edge 626, if present, and/or the sixth longitudinal edge 628, if present, of the third surface 620 may be inside the longitudinal edge imaginary cross-sectional concentric circle 636.

A combination of porting and at least one of the first trailing edge 424, and/or the second trailing edge 524, and/or the third trailing edge 624 being adjacent to the internal wall of the tube may induce flow through the porting, increasing radial flow and/or disturbance of at least one fluid(s), and may allow for efficient mixing and/or heat transfer; radial flow and/or disturbance favour mixing. The efficient mixing and/or heat transfer is explained in further detail below with reference to FIG. 13. Additionally or alternatively, flow through the porting, as described above, may induce turbulence in the flow of at least one fluid(s), and may allow for efficient mixing and/or heat transfer; turbulence favours mixing. In particular, turbulence may be favoured in certain fluids, such as a mixture of gas(es) and low viscosity fluid(s).

Use of the insert 410 may comprise flowing at least one fluid from the leading end of the tube 402 to the trailing end of the tube 402 along a Z axis. At least one of the first surface 420 may transition from the first concave surface portion 430 to the first convex surface portion 432 along the Z-axis Z; and/or the second surface 520, if present, may transition from the second concave surface portion 530 to the second convex surface portion 532 along the Z-axis Z; and/or the third surface 620, if present, may transition from the third concave surface portion 630 to the third convex surface portion 632 along the Z-axis Z.

Inserts 410 including a first surface 420 including a first surface 420 having a first concave surface portion 430 and a first convex surface portion 432, and a second surface 520 including a second surface 520 having a second concave surface portion 530 and a second convex surface portion 532, and a third surface including a third surface 620 having a third concave surface portion 630 and a third convex surface portion 632, may provide particularly efficient mixing and/or heat transfer of fluid(s). In particular, disturbed flow across the first surface 410 may be maintained in an first imaginary cross-sectional sector 438 of the tube 402, disturbed flow across the second surface 510 may be maintained in a second cross-sectional sector 538 of the tube 402, and disturbed flow across the third surface 610 may be maintained in a third cross-sectional sector 638 of the tube 402. In particular, the disturbed flow caused by such an insert 410 has been found to be significant relative to the pressure drop caused, more so for the inserts of embodiment 410 than similar FIG. 1 embodiments. Additionally or alternatively, turbulent flow across the first surface 410 may be maintained in an first imaginary cross-sectional sector 438 of the tube 402, turbulent flow across the second surface 510 may be maintained in a second cross-sectional sector 538 of the tube 402, and turbulent flow across the third surface 610 may be maintained in a third cross-sectional sector 638 of the tube 402. Turbulence may be favoured in certain fluids, such as a mixture of gas(es) and low viscosity fluid(s). In particular, the turbulent flow caused by such an insert 410 has been found to be significant relative to the pressure drop caused, more so for the inserts of embodiment 410 than similar FIG. 1 embodiments.

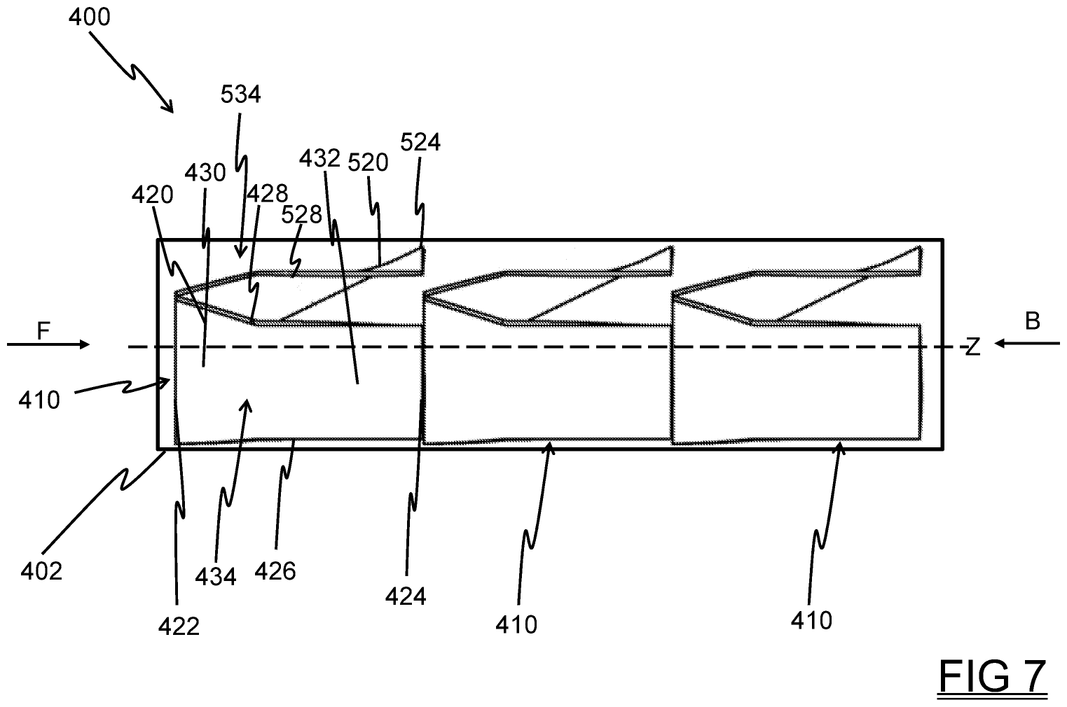

With reference to FIG. 7, there is provided a static mixer 400 including an insert 410 as described above, and an additional insert 410 for a static mixer 400. The additional insert 410 may have any of the features of the insert 410 as described above.

The insert 410 and additional insert 410 may be unitary.

There may also be provided a static mixer 400, the static mixer 400 may include multiple inserts 410.

Use of the insert 410 may comprise flowing at least one fluid from the leading end of the tube 402 to the trailing end of the tube 402. Accordingly, the insert 410 may be configured such that fluid flows across the first surface 420, second surface 520, if present, and third surface 620, if present, simultaneously at one cross-section normal to the mean flow direction in a first direction F. The first surface 420, second surface 520, and third surface 620 may be configured such that fluid flows sequentially across the first concave surface portion 430, the second concave surface portion 530, if present, and the third concave surface portion 630, if present, simultaneously, and then the first convex surface portion 432, second convex surface portion 532, if present, and third convex surface portion 632, if present, simultaneously. The fluid then flows sequentially across the first surface 420, second surface 520, and third surface 620 of the additional insert 410 or multiple inserts 410, if present. Alternatively, the insert 410 may be configured such that fluid flows sequentially across the first surface 420, second surface 520, if present, and third surface 620, if present, of the additional insert 410 or multiple inserts 410 at one cross-section normal to the mean flow direction in a second direction B. The first surface 420, second surface 520, if present, and third surface 620, if present, may be configured such that fluid flows sequentially across the first convex surface portion 432, the second convex surface portion 532, if present, and the third convex surface portion 632, if present, simultaneously, and then the first concave surface portion 432, second concave surface portion 532, if present, and third concave surface portion 632, if present, simultaneously. The fluid may then flow sequentially across the first surface 420, second surface 520, and third surface 620 of the first insert 410.

A static mixer including an insert 410 and a tube 402 further including an additional insert 410 or multiple inserts 410 may provide particularly efficient mixing and/or heat transfer of fluid(s) by maintaining a disturbed flow throughout the tube 402. In particular, flow from the first insert 410 to the additional insert 410 or multiple inserts 410 may increase disturbance of the flow, and the flow disturbance at the additional insert 410 and/or multiple inserts 410 may induce increased disturbance in the flow. Additionally or alternatively, flow from the first insert 410 to the additional insert 410 or multiple inserts 410 may increase turbulence of the flow, and the turbulence at the additional insert 410 and/or multiple inserts 410 may induce increased turbulence in the flow; turbulence favours mixing and heat transfer.

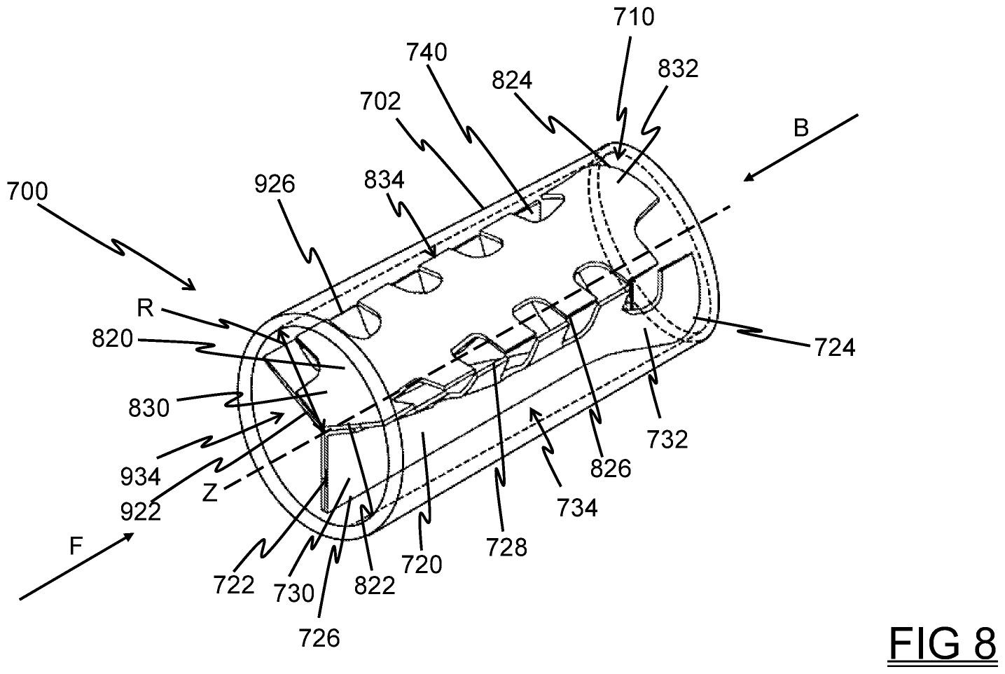

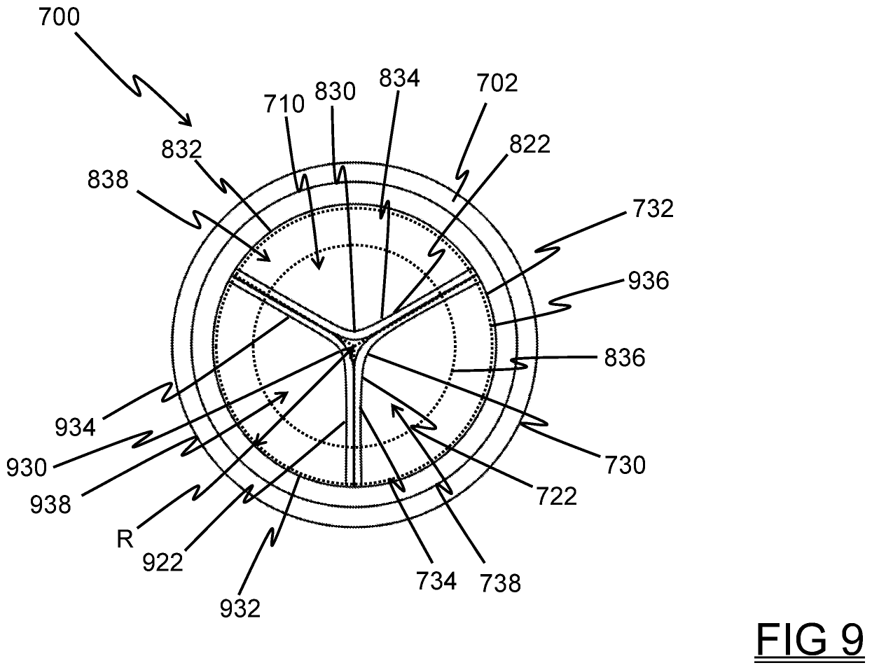

Referring to FIGS. 8 and 9, there is provided an insert 710 for a static mixer 700. The static mixer 700 includes the insert 710 and a tube 702. In use, and as shown, the insert 710 is within the tube 702. The insert 710 and static mixer 700 are described with reference numerals having like numerals to those of the inserts 110, 410 and static mixers 100, 400 as described above, with the addition of 600 and/or 300. Features and advantages described with reference to the insert 110, 410 and static mixers 100, 400 may be combined or obtained with insert 710 and static mixer 700, where appropriate. The insert 710 has a first surface 720 including a first leading edge 722 and a first trailing edge 724 joined by a first longitudinal edge 726 and a second longitudinal edge 728. The first surface 720 has a first concave surface portion 730 at or adjacent the first leading edge 722 and a first convex surface portion 732 at or adjacent the first trailing edge 724. Accordingly, there may be a curvature of the first surface 720 at or adjacent the first leading edge 722 in a first direction, and there may be a curvature of the first surface 720 at or adjacent the first trailing edge 724 in a second, opposite direction.

The insert 710 may include multiple segments including a first segment 734 wherein the first segment 734 includes the first surface 720.

The tube 702 may have a circular cross-section and the first leading edge 722 of the first surface 720 may be contained inside a first cross-sectional sector 738 of the tube 702.

The insert 710 may further include a second segment 834 and the second segment 834 includes a second surface 820 including a second leading edge 822 and a second trailing edge 824 joined by a third longitudinal edge 826 and fourth longitudinal edge 828. The second surface 820 has a second concave surface portion 830 at or adjacent the second leading edge 822 and a second convex surface portion 832 at or adjacent the second trailing edge 824. Accordingly, there may be a curvature of the second surface 820 at or adjacent the second leading edge 822 in a first direction, and there may be a curvature of the second surface 820 at or adjacent the second trailing edge 824 in a second, opposite direction.

The second leading edge 822 of the second surface 820, if present, may be contained inside a second cross-sectional sector 838 of the tube 702.

The insert 710 may further include a third segment 934 and the third segment 934 may include a third surface 920 including a third leading edge 922 and a third trailing edge 924 joined by a fifth longitudinal edge 926 and sixth longitudinal edge 928. The third surface 920 may have a third concave surface portion 930 at or adjacent the third leading edge 922 and a third convex surface portion 932 at or adjacent the third trailing edge 924. Accordingly, there may be a curvature of the third surface 920 at or adjacent the third leading edge 922 in a first direction, and there may be a curvature of the third surface 920 at or adjacent the third trailing edge 924 in a second, opposite direction.

The third leading edge 822 of the third surface 820. if present, may be contained inside a third cross-sectional sector 938 of the tube 702.

At least 10 to 45 percent of a length of the first leading edge 722 may be adjacent at least 10 to 45 percent of a length of at least one of the second leading edge 822, if present, and/or the third leading edge 922, if present. Alternatively, at least 10 to 50 percent; or 5 to 25 percent; or 10 to 60 percent of a length of the first leading edge 722 may be adjacent at least 10 to 50; or 5 to 25 percent; or 10 to 60 percent of a length of at least one of the second leading edge 822, if present, and/or the third leading edge 922, if present.

There may also be provided an insert 710, wherein the tube 702 may have a circular cross-section having a radius R, and the tube 702 may have a trailing edge imaginary cross-sectional concentric circle 836 having a radius of at least 10%; 20%; 30%; 40%; 50%; 60%; 70%; 80%; or 90% of the radius of the tube 702. At least one of the first trailing edge 724 of the first surface may be outside the trailing edge imaginary cross-sectional concentric circle 836; and/or the second trailing edge 824 of the second surface 820, if present, may be outside the trailing edge imaginary cross-sectional concentric circle 836; and/or the third trailing edge 924 of the third surface 920, if present, may be outside the trailing edge imaginary cross-sectional concentric circle 836. An imaginary cross-sectional concentric circle may not be limited to a circle by definition. An imaginary cross-sectional concentric circle may be replaced by an imaginary concentric cylinder along a portion of the tube 102, 402, 702; the length of the cylinder may correspond with the length of a segment 134, 234, 334, 434, 534, 634, 734, 834, 934.

Leading edges 122, 222, 322, 422, 522, 622, 722, 822, 922 and/or trailing edges 124, 224, 324, 424, 524, 624, 724, 824, 924, as described herein, when described as being outside of each respective leading edge imaginary cross-sectional concentric circle 136 and/or each respective trailing edge imaginary cross-sectional concentric circle 236, 536, 856, may be considered to be located entirely outside of each respective imaginary cross-sectional concentric circle as described herein, such that none of the respective leading edge 122, 222, 322, 422, 522, 622, 722, 822, 922 and/or trailing edge 124, 224, 324, 424, 524, 624, 724, 824, 924 is located within the respective imaginary cross-sectional concentric circle.

The tube 702 may have a circular cross-section having a radius R, and the tube may have a longitudinal edge imaginary cross-sectional concentric circle 936 having a radius of at most 97%; 95%; 90%; 85%; 80%; 70%; 60%; 50%; 40%; or 35% of the radius R of the tube 702, and at least one of the first longitudinal edge 726 and/or the second longitudinal edge 728 of the first surface 720 may be inside the longitudinal edge imaginary cross-sectional concentric circle 936; and/or the third longitudinal edge 826, if present, and/or the fourth longitudinal edge 828, if present, of the second surface 820 may be inside the longitudinal edge imaginary cross-sectional concentric circle 936; and/or the fifth longitudinal edge 926, if present, and/or the sixth longitudinal edge 928, if present, of the third surface 920 may be inside the longitudinal edge imaginary cross-sectional concentric circle 936.

Use of the insert 710 may comprise flowing at least one fluid from the leading end of the tube 702 to the trailing end of the tube 702 substantially along a Z-axis Z. At least one of the first surface 720 may transition from the first concave surface portion 730 to the first convex surface portion 732 along the Z-axis Z; and/or the second surface 820, if present, may transition from the second concave surface portion 830 to the second convex surface portion 832 along the Z-axis Z; and/or the third surface 920, if present, may transition from the third concave surface portion 930 to the third convex surface portion 932 along the Z-axis Z.

The insert 710 may further be configured such that the first longitudinal edge 726 and/or the second longitudinal edge 728 of the first surface 720 includes at least one notch 740, and/or the third longitudinal edge 826 and/or the fourth longitudinal edge 828 of the second surface 820, if present, includes at least one notch 740; and/or the fifth longitudinal edge 926 and/or the sixth longitudinal edge 928 of the third surface 920, if present, includes at least one notch 740. By notch it is meant a hole on the edge of a part.

A static mixer including an insert 710 and a tube 702 wherein the insert has at least one notch 740 may provide particularly efficient mixing and/or heat transfer of fluid(s). In particular, the notch 740 may increase disturbance in the fluid flow; flow disturbance favours mixing and heat transfer. Additionally or alternatively, the notch 740 may increase turbulence in the fluid flow; turbulence favours mixing and heat transfer.

Use of the insert 710 may involve flowing fluid(s) from a leading end of the tube 702 to a trailing end of the tube 702 along the Z-axis Z; and at least two of the following edges may include a notch 740: the first longitudinal edge; the second longitudinal edge; the third longitudinal edge, if present; the fourth longitudinal edge, if present; the fifth longitudinal edge, if present; and/or the sixth longitudinal edge, if present. The notches may be offset one another along the Z-axis Z.

The insert 710 may include at least one notch 740 on any of the first trailing edge 724 of the first surface 720; and/or the second trailing edge 824 of the second surface 820, if present; and/or the third trailing edge 924 of the third surface 920, if present.

Use of the insert 710 may comprise flowing at least one fluid from the leading end of the tube 702 to the trailing end of the tube 702. Accordingly, in preferred embodiments, the insert 710 may be configured such that fluid flows across the first surface 720, second surface 820, and third surface 920 simultaneously in a first direction F. The first surface 720, second surface 820, and third surface 920 may be configured such that fluid flows sequentially across the first concave surface portion 730, the second concave surface portion 830, and the third concave surface portion 930 simultaneously, and then the first convex surface portion 732, second convex surface portion 832, and third convex surface portion 932 simultaneously, and then and then through the at least one notch 740. Alternatively, in less-preferred embodiments, the insert 710 may be configured such that fluid flows across the first surface 720, second surface 820, and third surface 920 simultaneously in a second direction B. The first surface 720, second surface 820, and third surface 920 may be configured such that fluid flows sequentially across the first convex surface portion 732, the second convex surface portion 832, and the third convex surface portion 932 simultaneously, and then the first concave surface portion 730, second concave surface portion 830, and third concave surface portion 930 simultaneously, and then and then through the at least one notch 740.

A static mixer including an insert 710 and a tube 702 wherein the insert has at multiple notches 740 as described above may provide particularly efficient mixing and/or heat transfer of fluid(s) by maintaining a disturbed flow throughout the tube 702. In particular, flow through the notches 740 may introduce a knitted flow in the fluid(s), resulting in increased radial flow and/or disturbance in the flow of fluid(s) for a relatively low pressure drop. Additionally or alternatively, flow through the notches 740 may introduce a knitted flow in the fluid(s), resulting in increased turbulence in the flow of fluid(s) for a relatively low pressure drop.

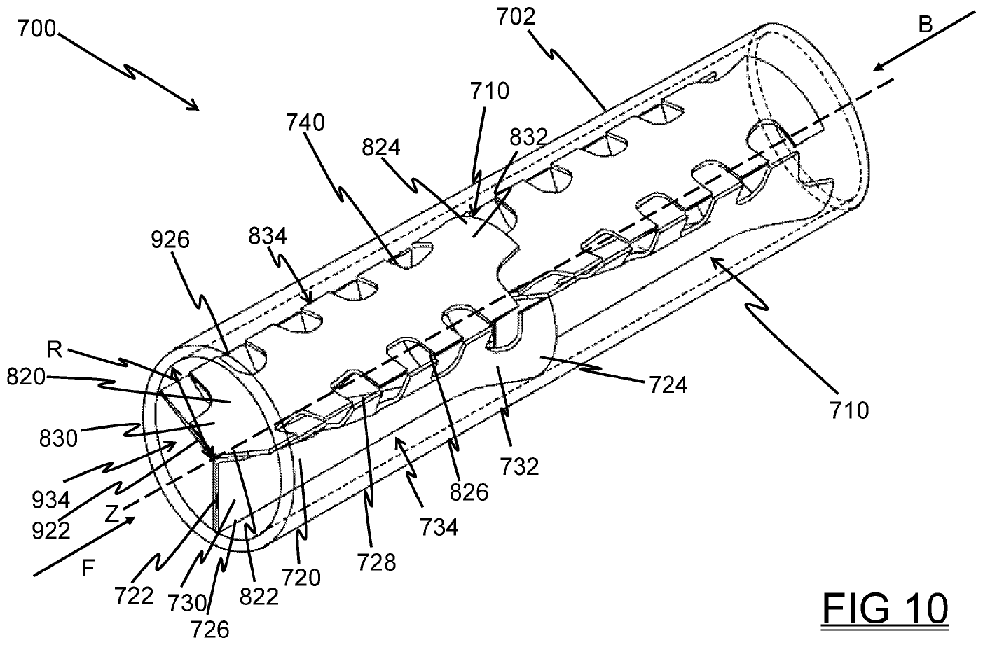

Referring to FIG. 10 there is provided an insert 710 as described above and an additional insert 710 for a static mixer 700. The additional insert 710 may have any of the features of the insert 710 as described above.

The insert 710 and additional insert 710 may be unitary.

There may also be provided a static mixer 700, the static mixer 700 may include multiple inserts 710.

Use of the insert 710 may comprise flowing at least one fluid from the leading end of the tube 702 to the trailing end of the tube 702. Accordingly, the insert 710 may be configured such that fluid flows across the first surface 720, second surface 820, if present, and third surface 920, if present, simultaneously in a first direction F. The first surface 720, second surface 820, if present, and third surface 920, if present, may be configured such that fluid flows sequentially across the first concave surface portion 730, the second concave surface portion 830, if present, and the third concave surface portion 930, if present, simultaneously, and then the first convex surface portion 732, second convex surface portion 832, if present, and third convex surface portion 932, if present, simultaneously, and then through the at least one notch 740. Alternatively, the insert 710 may be configured such that fluid flows across the first surface 720, second surface 820, if present, and third surface 920, if present, simultaneously in a second direction B.

A static mixer including an insert 710 and a tube 702 further including an additional insert 710 or multiple inserts 710 wherein the insert 710 and additional insert 710 has at least one notch 740 may provide particularly efficient mixing and/or heat transfer of fluid(s) by maintaining a disturbed flow throughout the tube 702. In particular, flow through the at least one notch may introduce a knitted flow in the fluid(s) and the at least one additional insert 710 provides further disturbed flow, which may result in more efficient mixing and/or heat transfer of the fluid(s). In particular, flow through the at least one notch may introduce a knitted flow in the fluid(s) and the at least one additional insert 710 provides further disturbed flow, which may result in more efficient mixing and/or heat transfer of the fluid(s).

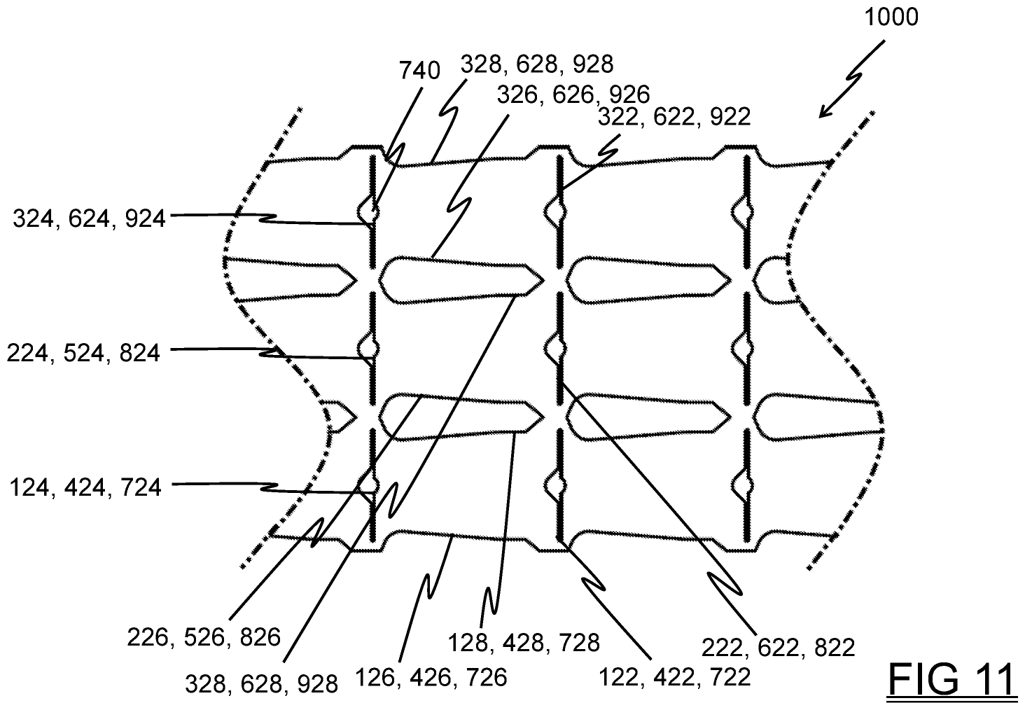

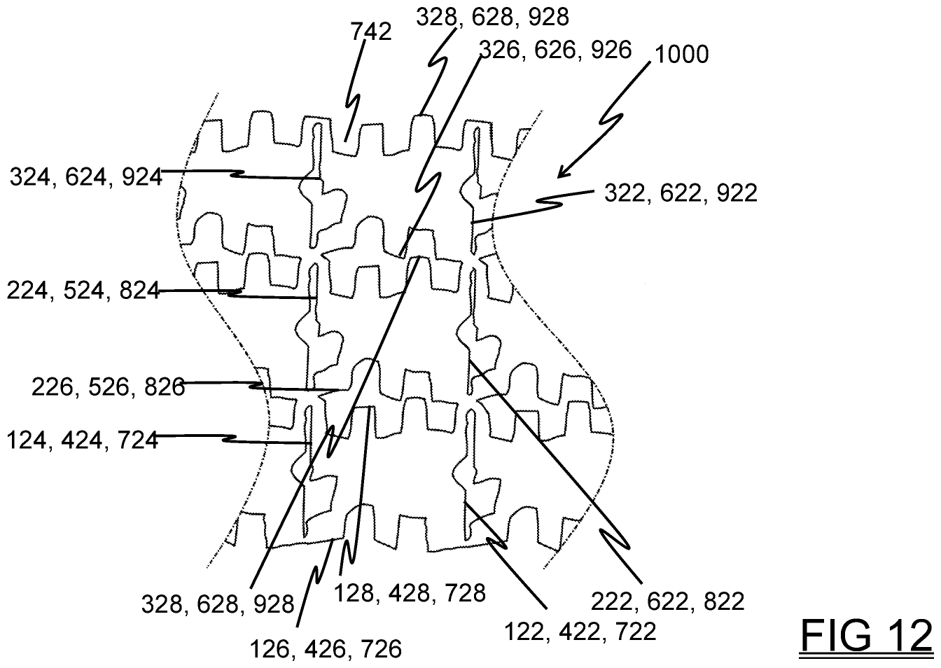

Referring to FIGS. 11 and 12 there is also provided a net 1000 for forming an insert 110, 410, 710 as described above The net may include any features of inserts 110, 410, 710, including, but not limited to; notches 740; and/or porting as described above; longitudinal edges 126, 128, 226, 228, 326, 328, 426, 428, 526, 528, 626, 628, 726, 728, 826, 828, 926, 928; and/or leading edges 122, 222, 322, 422, 522, 622, 722, 822, 922; and/or trailing edges 124, 224, 324, 424, 524, 624, 724, 824, 924, as described above. The net 1000 may also include at least one notch 742. The at least one notch 742 may have an irregular shape or a regular.

FIG. 13 shows multiple leading edge cross-sectional views at cross-sections along the Z-axis Z in the first direction of flow F.

With reference to FIG. 13a, fluid flow may be induced away from the centre of the tube 402 by the first leading edge 422, second leading edge 522, and third leading edge 622 of the insert 410.

With reference to FIG. 13b, fluid flow may be further directed away from the centre of the tube 402, and induced around and over the porting at the longitudinal edges 426, 428, 526, 528, 626, 628 as described above.

With reference to FIG. 13c, fluid flow may be further directed back towards the centre of the tube 402 in a cyclical motion. Such fluid flow may cause fluid flow streams to meet, increasing disturbance in the fluid and increasing mixing. When the flow streams meet, disturbance in the fluid may be induced and/or increased, increasing mixing.

With reference to FIG. 13d, fluid flow may be cyclical near the centre of the tube, and the first surface 420, second surface 520, and third surface 620, may direct flow to the internal wall of the tube 402. The induced cyclical fluid may increase flow disturbance, and therefore mixing efficiency. Additionally or alternatively, the induced cyclical fluid may increase turbulence, and therefore mixing efficiency. The fluid being directed towards the internal wall of the tube 402 may increase heat transfer efficiency; flow directed from the centre of the tube 402 to the wall of the tube 402 favours heat transfer; particularly, flow near the wall of the tube 402 favours heat transfer.

With reference to FIG. 13e, fluid flow may be further directed to the internal wall of the tube 402, and cyclical flow may be maintained within the tube 402.

With reference to FIG. 13f, fluid flow may further be induced away from the centre of the tube 402 by the first leading edge 422, second leading edge 522, and third leading edge 622 of an additional insert 410. Fluid flow may be induced near the internal wall of the tube 402 and the fluid near the centre of the tube 402 may be induced towards the internal wall of the tube 402. Static mixers 400 having an additional insert 410 may further may provide efficient mixing and/or heat transfer of fluid(s). In particular, disturbance at the additional insert 410 is greater than at the first insert 410.

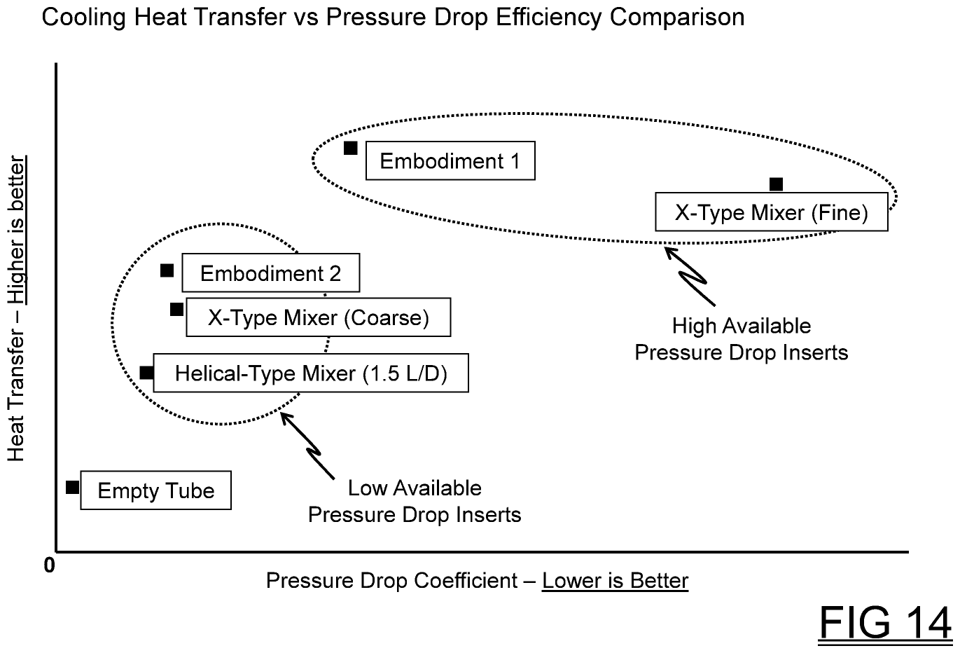

FIG. 14 is a graph showing pressure drop and heat transfer characteristics of static mixers of embodiments, and known static mixers. A static mixer 100, 400, 700, with an insert 110, 410, 710, and a tube 102, 402, 702 as described above, may designed for increased mixing capability and/or heat transfer of fluid(s). As shown in FIG. 14, Embodiment 1 (a high intensity embodiment) provides an increase in heat transfer compared with a prior art X-Type mixer (Fine), with a large reduction in pressure drop coefficient. Also as shown in FIG. 14, Embodiment 2 (a low intensity embodiment) provides an increase in heat transfer compared with a prior art X-Type mixer (Coarse) and a Helical-Type mixer, for a lower pressure drop than the X-Type mixer (Coarse) and only a marginally increased pressure drop compared with the Helical-Type mixer.

Inserts 110, 410, 710 may be used in chemical reactions. In particular, the flow characteristics induced on fluid(s) and the efficient heat transfer induced by the inserts 110, 410, 710 as described above may improve mixing and/or heat transfer of fluids, by inducing disturbed flow and/or radial flow. Efficient mixing and/or efficient heat transfer may provide advantages in, at least, chemical process and reaction control. Additionally or alternatively, inserts 110, 410, 710 as described above may induce turbulent flow in fluid(s); turbulent flow may improve chemical reaction mixing and/or heat transfer.

Inserts 110, 410, 710 may further include an inner tube (not shown). The inner tube may be positioned between the first segment 434, 734, second segment 534, 834, if present, and third segment 634, 934, if present. Inclusion of an inner tube may allow for heat transfer from fluid(s) in the tube 102, 402, 702 through an outer wall of the inner tube to fluid(s) within the inner tube. Such a configuration, as described above, may allow for multiple chemical reactions and/or mixing processes to occur simultaneously. Inclusion of an inner tube may also result in efficient heat transfer in the fluid(s) in the tube 102, 402, 702. Flow may be induced from substantially the centre of the tube 102, 402, 702, transferring heat from fluid(s) in the inner tube to fluid(s) in the tube 102, 402, 702, and/or transferring heat from fluid(s) the tube 102, 402, 702 to fluid(s) in the inner tube, through an inner tube wall. Flow may then be directed to the inner wall of the tube 102, 402, 702, as described above; flow near the inner wall of the tube 102, 402, 702 favours heat transfer.

There is also provided a method of making an insert 110, 410, 710 for a static mixer 100, 400, 700. The method may include providing a net 1000 as described above; and pressing the net 1000 and/or folding the net 1000 to form a static mixer 100, 400, 700 as described above.

There is also provided a method of improving a heat exchanger. The method may include inserting an insert 110, 410, 710, as described above into a tube of the heat exchanger.

Modification of the static mixers 100, 400, 700, the inserts 110, 410, 710, and the nets 1000 will be apparent to the skilled person. As examples, further embodiments and variations of the static mixers 100, 400, 700, the inserts 110, 410, 710, and the nets 1000 will be described below.

Use of the insert, 410, 710 may comprise flowing at least one fluid from the leading end of the tube 402, 702 to the trailing end of the tube 402, 702. The surface 420, 520, 620, 720, 820, 920 of the insert 410, 710 may induce flow in at least three directions normal to the mean direction of flow, toward the internal wall of the tube, 402, 702. The first surface 120, 420, 720 of the first segment 134, 434, 734 may induce flow in a third direction, and/or the second surface 220, 520, 820 of the second segment 234, 534, 834 may induce flow in a fourth direction; and/or the third surface 320, 620, 920 of the third segment 334, 634, 934 may induce flow in a fifth direction. An insert 410, 710, as described above, that may induce fluid(s) flow in at least three directions may be advantageous, in particular, the induced flow in the fluid(s) may induce cyclical flow, increasing flow disturbance and/or radial flow, and may direct the fluid(s) flow towards the internal wall of the tube 402, 702. Flow disturbance and radial flow favours mixing; fluid flow near the internal wall of the tube 402, 702 favours heat transfer.

The insert 110, 410, 710 may include a notch 740 on any of the first leading edge 122, 422, 722, the second leading edge 222, 522, 822, if present, and/or the third leading edge 322, 622, 922, if present. Inserts 110, 410, 710 including notch(es) 740 as described above with reference to the the first leading edge 122, 422, 722, the second leading edge 222, 522, 822, if present, and/or the third leading edge 322, 622, 922, if present, may enable ease of construction from the net 1000. In particular, the net 1000 may be more easily pressed and/or folded.

The insert, 410, 710 may form three divisions inside a cross-sectional plane of the tube 102, 402, 702 normal to the mean direction of flow.

The static mixer 710 may include at least one notch 742; the at least one notch 742 may have an irregular shape and/or the at least one notch 742 may be non-uniform.

The insert(s) 110, 410, 710 may have a length L of at least: 0.1 cm; 1 cm; 5 cm; or 10 cm.

The insert(s) 110, 410, 710 may have a length L of at most: 0.1 cm; 1 cm; 5 cm; 10 cm; 20 cm; 30 cm; 40 cm; or 50 cm;

The static mixer 100, 400, 700 may include multiple inserts 110, 410, 710 having the same length L.

The insert(s) 110, 410, 710 may have a diameter D of at least: 0.1 cm; 0.2 cm; 0.3 cm; 0.4 cm; 0.5 cm; 1 cm; 5 cm; or 10 cm.

The insert(s) 110, 410, 710 may have a diameter D of at most: 0.1 cm; 1 cm; 5 cm; 10 cm; 20 cm; 30 cm; 40 cm; or 50 cm.

The insert(s) 110, 410, 710 may have a length to diameter ratio (L/D) of at least: 0.1; 0.5; 1; 2; 5; 10; or 100.

The insert(s) 110, 410, 710 may have a length to diameter ratio (L/D) of at most: 0.1; 0.5; 1; 2; 5; 10; or 100.

The static mixer 100, 400, 700 may have a length LM of at least: 1 cm; 5 cm; 10 cm; 100 cm; 1 m; 100 m; or 1000 m.

The notch(es) 740 may have a longest dimension of at least: 0.01 cm; 0.1 cm; 1 cm; or 2 cm.

The notch(es) 740 may have a longest dimension of at most: 0.01 cm; 0.1 cm; 1 cm; or 2 cm.

Use of the insert 110, 410, 710 may comprise flowing at least one fluid from the leading end of the tube 102 to the trailing end of the tube 102, 402, 702. In use, heat in the fluid may be transferred to a surrounding environment through a wall of the tube 102, 402, 702. The surrounding environment may be and/or include a liquid and/or a gas.

The net 1000 may be pressed hydraulically, or mechanically; or pneumatically.

The insert 110, 410, 710 may consist of or include a metallic material, and/or a metal, and/or an alloy.

The net 1000 may consist of or include a metallic material, and/or a metal, and/or an alloy.

Use of the insert 110, 410, 710 may comprise flowing at least one fluid from the leading end of the tube 102, 402, 702 to the trailing end of the tube 102, 402, 702. The tube 102, 402, 702 may have a longitudinal edge imaginary cross-sectional concentric circle 336, 636, 936 having a radius of at most 97%; 95%; 90%; 85%; 80%; 70%; 60%; 50%; 40%; or 35% of the radius R of the tube; and at least one of: the first longitudinal edge 126, 426, 726 of the first surface 120, 420, 720 may be inside the longitudinal edge imaginary cross-sectional concentric circle 336, 636, 936 at an at least one position along the Z-axis Z and outside the longitudinal edge imaginary cross-sectional concentric circle 336, 636, 936 at an at least one position along the Z-axis Z; and/or the longitudinal edge 128, 428, 728 of the first surface 120, 420, 720 may be inside the longitudinal edge imaginary cross-sectional concentric circle 336, 636, 936 at an at least one position along the Z-axis Z and outside the longitudinal imaginary edge cross-sectional concentric circle at an at least one position along the Z-axis Z; and/or the third longitudinal edge 226, 526, 826 of the second surface 220, 520, 820, if present, may be inside the longitudinal edge imaginary cross-sectional concentric circle 336, 636, 936 at an at least one position along the Z-axis Z and outside the longitudinal edge imaginary cross-sectional concentric circle 336, 636, 936 at an at least one position along the Z-axis Z; and/or the fourth longitudinal edge 228, 528, 828 of the second surface 220, 520, 820, if present, may be inside the longitudinal edge imaginary cross-sectional concentric circle 336, 636, 936 at an at least one position along the Z-axis Z and outside the longitudinal edge imaginary cross-sectional concentric circle 336, 636, 936 at an at least one position along the Z-axis Z; and/or the fifth longitudinal edge 326, 626, 926 of the third surface 320, 620, 920, if present, may be inside the longitudinal edge imaginary cross-sectional concentric circle 336, 636, 936 at an at least one position along the Z-axis Z and outside the longitudinal edge imaginary cross-sectional concentric circle 336, 636, 936 at an at least one position along the Z-axis Z; and/or the sixth longitudinal edge 328, 628, 928 of the third surface 320, 620, 920, if present, may be inside the longitudinal edge imaginary cross-sectional concentric circle 336, 636, 936 at an at least one position along the Z-axis Z and outside the longitudinal edge imaginary cross-sectional concentric circle 336, 636, 936 at an at least one position along the Z-axis Z.

When used in this specification and claims, the term “fluid” may refer to a fluid and/or a fluid mixture (e.g., a liquid-liquid mixture, a liquid-gas mixture, or a liquid-solid mixture), and may be any known liquid/fluid as is known per se (e.g., water, alcohols, acids, solvents, solvent-solute mixtures, etc.).

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. An insert for a static mixer, wherein:
the static mixer includes the insert and a tube, and, in use, the insert is within the tube;
the insert has a first surface including a first leading edge and a first trailing edge joined by a first longitudinal edge and a second longitudinal edge; and
the first surface has a first concave surface portion at or adjacent the first leading edge and a first convex surface portion at or adjacent the first trailing edge.

2. An insert according to claim 1, wherein:
the tube has a circular cross-section having a radius;
the tube has a trailing edge imaginary cross-sectional concentric circle having a radius of at least 60% of the radius of the tube; and
the first trailing edge of the first surface is outside the trailing edge imaginary cross-sectional concentric circle.

3. An insert according to claim 1 wherein the insert includes multiple segments including a first segment and wherein the first segment includes the first surface.

4. An insert according to claim 1 wherein:
the tube has a circular cross-section; and
the first leading edge of the first surface is contained inside a first imaginary cross-sectional sector of the tube.

5. An insert according to claim 1 wherein the insert includes a second segment and the second segment includes a second surface including a second leading edge and a second trailing edge joined by a third longitudinal edge and fourth longitudinal edge; and
the second surface has a second concave surface portion at or adjacent the second leading edge and a second convex surface portion at or adjacent the second trailing edge.

6. An insert according to claim 5 wherein:
the tube has a circular cross-section; and
the second leading edge of the second surface is contained inside a second imaginary cross-sectional sector of the tube.

7. An insert according to claim 5 wherein the insert includes a third segment and the third segment includes a third surface including a third leading edge and a third trailing edge joined by a fifth longitudinal edge and sixth longitudinal edge; and
the third surface has a third concave surface portion at or adjacent the third leading edge and a third convex surface portion at or adjacent the third trailing edge.

8. An insert according to claim 7 wherein:
the tube has a circular cross-section; and
the third leading edge of the third surface is contained inside a third imaginary cross-sectional sector of the tube.

9. An insert according to claim 5 wherein at least 10 to 45 percent of a length of the first leading edge is adjacent at least 10 to 45 percent of a length of at least one of the second leading edge, if present, and/or the third leading edge, if present.

10. An insert according to claim 1 wherein:
the tube has a circular cross-section having a radius;
the insert has a leading edge imaginary cross-sectional concentric circle having a radius of at least 60% of the radius of the tube, and
the first leading edge of the first surface is outside the leading edge imaginary cross-sectional concentric circle; and/or
the second leading edge of the second surface, if present, is outside the leading edge imaginary cross-sectional concentric circle; and/or
the third leading edge of the third surface is outside the leading edge imaginary cross-sectional concentric circle.

11. An insert according to claim 1 wherein:
the tube has a circular cross-section having a radius; and
the tube has a trailing edge imaginary cross-sectional concentric circle having a radius of at least 60% of the radius of the tube; and at least one of:
the second trailing edge of the second surface, if present, is outside the trailing edge imaginary cross-sectional concentric circle; and/or
the third trailing edge of the third surface, if present, is outside the trailing edge imaginary cross-sectional concentric circle.

12. An insert according to claim 1 wherein:
the tube has a circular cross-section having a radius; and
the tube has a longitudinal edge imaginary cross-sectional concentric circle having a radius of at most 97% of the radius of the tube, and at least one of:
the first longitudinal edge and/or the second longitudinal edge of the first surface are inside the longitudinal edge imaginary cross-sectional concentric circle; and/or
the third longitudinal edge, if present, and/or the fourth longitudinal edge, if present, of the second surface is inside the longitudinal edge imaginary cross-sectional concentric circle; and/or
the fifth longitudinal edge, if present, and/or the sixth longitudinal edge, if present, of the third surface is inside the longitudinal edge imaginary cross-sectional concentric circle.

13. An insert according to claim 1 wherein:
in use, flow proceeds from a leading end of the tube to a trailing end of the tube substantially along a Z-axis; and at least one of:
the first surface transitions from the first concave surface portion to the first convex surface portion along the Z-axis; and/or
the second surface, if present, transitions from the second concave surface portion to the second convex surface portion along the Z-axis; and/or
the third surface, if present, transitions from the third concave surface portion to the third convex surface portion along the Z-axis.

14. An insert according to claim 1 wherein at least one of:
the first longitudinal edge and/or the second longitudinal edge of the first surface includes at least one notch; and/or
the third longitudinal edge and/or the fourth longitudinal edge of the second surface, if present, includes at least one notch; and/or
the fifth longitudinal edge and/or the sixth longitudinal edge of the third surface, if present, includes at least one notch.

15. An insert according to claim 1 wherein:
in use, flow proceeds from a leading end of the tube to a trailing end of the tube substantially along a Z-axis; and
at least two of the following edges include a notch:
the first longitudinal edge;
the second longitudinal edge;
the third longitudinal edge, if present;
the fourth longitudinal edge, if present;
the fifth longitudinal edge, if present; and/or
the sixth longitudinal edge, if present;
and wherein the notches are offset one another along the Z-axis.

16. An insert according to claim 1 wherein at least one of:
the first trailing edge of the first surface includes at least one notch; and/or
the second trailing edge of the second surface, if present, includes at least one notch; and/or
the third trailing edge of the third surface, if present, includes at least one notch.

17-18. (canceled)

19. A static mixer, including a tube and an insert according to claim 1, wherein, in use, the insert is inside the tube.

20. (canceled)

21. Use of a static mixer according to claim 19 in heat transfer and/or mixing.

22. The use of claim 21 wherein the use comprises flowing at least one fluid from the leading end of the tube to the trailing end of the tube.

23. The use of claim 22 wherein the use comprises flowing the at least one fluid sequentially across the first concave surface portion and then the first convex surface portion.

24-26. (canceled)
